(19) United States
(12) Patent Application Publication
(10) Pub. No.: US 2025/0086632 A1
(43) Pub. Date: Mar. 13, 2025

(54) INFORMATION PROCESSING APPARATUS, INFORMATION PROCESSING SYSTEM, INFORMATION PROCESSING METHOD, AND NON-TRANSITORY COMPUTER-READABLE MEDIUM HAVING PROGRAM STORED THEREIN

(71) Applicant: NEC Corporation, Minato-ku, Tokyo (JP)

(72) Inventors: Risa Tagawa, Tokyo (JP); Tomohide Ota, Tokyo (JP)

(73) Assignee: NEC Corporation, Minato-ku, Tokyo (JP)

(21) Appl. No.: 18/723,900

(22) PCT Filed: Mar. 28, 2022
(86) PCT No.: PCT/JP2022/014760

§ 371 Date: Jun. 25, 2024

(51) Int. Cl. G06Q 20/40

(52) U.S. Cl. CPC G06Q 20/40145

(57) ABSTRACT

An information processing apparatus (1) includes a managing unit (11) that manages, for each store, biometric information of a user and member information in association with each other, an acquiring unit (12) that acquires biometric information of a user from a terminal installed for each store, a specifying unit (13) that specifies member information, based on the acquired biometric information of a user, and a processing unit (14) that causes the terminal to execute payment processing by using the specified member information. The processing unit (14) can cause the terminal to output information desired to be notified to a user in payment to which the member information is applied.

### TECHNICAL FIELD

The present disclosure relates to an information processing apparatus, an information processing system, an information processing method, and a non-transitory computer-readable medium storing a program.

### BACKGROUND ART

In order to benefit from a point and a discount when purchasing a product at a store, there is a system to use a member card and a coupon. When using the system, a customer needs to present a member card or the like that differs for each store to each store clerk or cause a point of sales (POS) terminal to read the member card or the like. For this reason, a customer possesses member cards and the like of a large number of stores, and thereby there is a case of inconvenient.

Thus, Patent Literature 1 discloses an information processing system capable of specifying a member code of a customer at a time of payment even when the customer does not possess a medium indicating the member code. The information processing system includes an authentication apparatus and a server. The authentication apparatus acquires a face photograph of a customer, reads a barcode attached to a shopping basket that the customer can carry around at a time of shopping, and transmits, to the server, the face photograph and the barcode in association with each other.

The server stores a member code of a member registered in advance and a face photograph in association with each other. When the server acquires a face photograph from the authentication apparatus, the server specifies the member code of a customer from the face photograph, and associates the member code and the bar code with each other. At the time of payment, the server transmits, to a POS terminal, the member code of the customer associated with the barcode of the shopping basket read by the POS terminal.

### CITATION LIST

### Patent Literature

Patent Literature 1: Japanese Unexamined Patent Application Publication No. 2021-135591

### SUMMARY OF INVENTION

### Technical Problem

In Patent Literature 1, it is necessary to associate a member code of a customer and a barcode of a shopping basket with each other, and there is a problem of lack of convenience.

In view of the above-described problem, an object of the present disclosure is to provide an information processing apparatus, an information processing system, an information processing method, and a program that enhance convenience of a user at a time of purchasing a product in a store.

### Solution to Problem

An information processing apparatus according to one aspect of the present disclosure includes:
a managing means for managing, for each store, biometric information of a user and member information in association with each other;
an acquiring means for acquiring biometric information of a user from a terminal installed for each store;
a specifying means for specifying member information, based on the acquired biometric information of a user; and
a processing means for causing the terminal to execute payment processing by using the specified member information.

An information processing system according to one aspect of the present disclosure includes:
a terminal installed for each store; and
an information processing apparatus, wherein
the information processing apparatus includes
   a managing means for managing, for each store, biometric information of a user and member information in association with each other, an acquiring means for acquiring biometric information of a user from the terminal,
   a specifying means for specifying member information, based on the acquired biometric information of a user, and
   a processing means for causing the terminal to execute payment processing by using the specified member information.

An information processing method according to one aspect of the present disclosure includes, by a computer:

managing, for each store, biometric information of a user and member information in association with each other;
acquiring biometric information of a user from a terminal installed for each store; specifying member information, based on the acquired biometric information of a user; and
causing the terminal to execute payment processing by using the specified member information.

A program according to one aspect of the present disclosure causes a computer to execute:
processing of managing, for each store, biometric information of a user and member information in association with each other;
processing of acquiring biometric information of a user from a terminal installed for each store;
processing of specifying member information, based on the acquired biometric information of a user; and
processing of causing the terminal to execute payment processing by using the specified member information.

### Advantageous Effects of Invention

According to the present disclosure, it is possible to enhance convenience of a user at a time of purchasing a product in a store.

### BRIEF DESCRIPTION OF DRAWINGS

FIG. 1 is a block diagram illustrating a configuration of an information processing apparatus according to a first example embodiment;

FIG. 2 is a flowchart for describing a flow of an information processing method according to the first example embodiment;

FIG. 3 is a block diagram illustrating an overall configuration of an information processing system according to a second example embodiment;

FIG. 4 is a block diagram illustrating a configuration of a user terminal in FIG. 3;

FIG. 5 is a block diagram illustrating a configuration of an authentication terminal in FIG. 3;

FIG. 6 is a block diagram illustrating a configuration of an authentication apparatus in FIG. 3;

FIG. 7 is a flowchart illustrating a flow of face information registration processing performed by the authentication apparatus according to the second example embodiment;

FIG. 8 is a block diagram illustrating a configuration of a server in FIG. 3;

FIG. 9 is a sequence diagram illustrating a flow of payment processing according to the second example embodiment;

FIG. 10 is a flowchart illustrating a flow of face authentication processing performed by the authentication apparatus according to the second example embodiment;

FIG. 11 is one example of a coupon selection screen; and

FIG. 12 is one example of a screen on which a payment result is displayed.

### EXAMPLE EMBODIMENT

Hereinafter, example embodiments of the present disclosure will be described in detail with reference to the drawings. In each of the drawings, the same or corresponding elements are denoted by the same reference signs, and redundant descriptions are omitted as necessary for clarity of description.

### First Example Embodiment

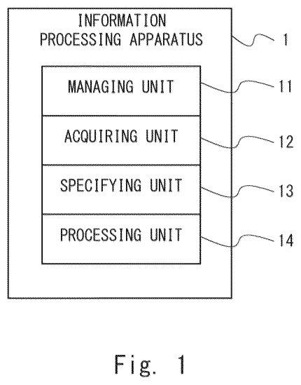

FIG. 1 is a block diagram illustrating a configuration of an information processing apparatus 1 according to a first example embodiment. The information processing apparatus 1 is an apparatus being capable of applying privilege information usable by a user at a time of purchasing a product in a store. The information processing apparatus 1 manages member information of a user in a database.

A user to be managed is a user who has registered in a member system that can use privilege information. The privilege information is, for example, a point given in response to payment (the number of times of payment, a payment amount, and the like), or a discount of a product price by a coupon. For example, a user being a member can acquire a predetermined service or the like according to a total point.

A user is registered as a member by, for example, describing a name, a contact address (an address, a phone number, a mail address, and the like), and other predetermined matters (user information) related to the user in an application form, and submitting the application form at a service counter of a store. Note that, by using a user terminal possessed by a user, the predetermined matter may be transmitted from a web page for member registration. Further, a user may transmit the predetermined matter via an application by using the user terminal.

Further, a user can register, in advance, payment information such as a valid credit card or electronic money that can be used for payment at a time of member registration. Such payment information is also included in the user information.

Each member is given a user ID such as a member number as unique identification information. In addition to the above-described user information, various types of attribute information including a visit history of a user, a purchase history, a payment amount, and privilege information (a point, a coupon, and the like) acquired and used are associated with the individual user ID. The member information includes user information including a name, a contact address, and payment information, and various types of attribute information.

In the related art, since a medium (a member card or the like) in which member information specifying a user is stored is issued for each store to be used, a user being a member of the store needs to possess member cards of a large number of stores. For this reason, when a privilege is used at the time of purchasing a product, a user needs to present a member card that differs for each store, and thereby it is troublesome.

Further, a coupon usable in a store may be various coupons such as an electronic coupon acquired by an application or a paper coupon. In a case where a plurality of coupons are acquired in one store, it is necessary to select and present a usable coupon among the plurality of coupons, and it is difficult to use the coupon when a checkout counter is congested. Meanwhile, a store clerk needs to handle each of a member card, a coupon, and a payment means presented by a member, therefore a register operation and handling becomes complicated and burdensome.

In view of such circumstance, the present inventor has devised the following configuration. The information processing apparatus 1 according to the first example embodiment is an apparatus being capable of applying privilege information even when a user does not possess a medium indicating the privilege information being usable at the time of purchasing a product in a store. The information processing apparatus 1 performs biometric authentication by using biometric information, and performs personal identification of a user.

A user registers his/her own biometric information (face, fingerprint, and the like) in advance at a time of member registration. As biometric authentication using biometric information, various techniques using a photographed image can be applied. As the biometric information, data (feature amount) based on a physical characteristic being unique to an individual such as a face, a fingerprint, a voice print, a vein, a retina, and an iris of a pupil can be used.

For example, a user can photograph his/her own face image with a camera provided in his/her own user terminal, and transmit the generated face image to the information processing apparatus 1 or an authentication apparatus as biometric information (for registration). Note that, a user's face image may be photographed by a terminal installed in a store and transmitted to the information processing apparatus 1 or the authentication apparatus.

The information processing apparatus 1 is connected to a predetermined terminal by a network (not illustrated) or a predetermined wireless communication. The network may be wired or wireless, and a type of communication protocol does not matter. The terminal transmits biometric information (for authentication) of a user to the information processing apparatus 1. Further, the terminal performs processing based on an output from the information processing apparatus 1 according to an authentication result. The terminal includes a store terminal installed in a store, a user terminal possessed by a user, and the like.

As illustrated in FIG. 1, the information processing apparatus 1 includes a managing unit 11, an acquiring unit 12, a specifying unit 13, and a processing unit 14. The managing unit 11 manages, for each store, biometric information (for registration) of a user and member information in association with each other. The managing unit 11 stores, for each store, the biometric information of a user and the member information in association with each other in a built-in or external storage apparatus. Herein, “for each store” may be “for one store”, or “for each group consisted of a plurality of stores in the same chain”. For example, when the store is a chain store, a franchise store, or the like, the biometric information of a user and the member information may be associated with each other for each individual store, or the biometric information of a user and the member information may be associated with each other for a group that supervises a plurality of stores. As described above, the member information includes user information and various types of attribute information.

Further, the biometric information of a user and the member information may be stored in association with each other for each store as a table 1, and also a table 2 in which the biometric information of a user and the member information are associated with each other without including information of a store may be generated. In a case where payment is performed at a store not being stored in the table 1, the payment can be performed with reference to the table 2. Note that, the table 2 may include payment information and information indicating a priority of a giving destination (a point card) of a point acquired by payment.

The acquiring unit 12 acquires biometric information (for authentication) of a user from a store terminal installed for each store. As one example, the biometric information may be a face image, and authentication of personal identification may be face authentication. For example, the store terminal includes a capturing apparatus such as a camera, and can generate a face image by photographing. The biometric information of a user may be automatically generated by the store terminal, or may be generated in response to an input from a user or a store clerk. Such a store terminal may be fixed to a necessary place in a store, or may be carried by a store clerk. A portable store terminal may be, for example, a mobile phone, a smartphone, a tablet, or the like.

The specifying unit 13 specifies member information, based on the acquired biometric information (for authentication) of a user. The specifying unit 13 can collate the biometric information for authentication with the biometric information for registration, and specify the member information when both of the biometric information matches each other. Note that, the store terminal may transmit the acquired biometric information to the authentication apparatus in which the biometric information (for registration) of a user is registered in advance, and transmit an authentication result to the information processing apparatus 1. The information processing apparatus 1 may receive the authentication result, and perform processing according to the received authentication result.

The processing unit 14 causes the store terminal to execute payment processing by using the specified member information. In the first example embodiment, when authentication of personal identification of a user is successful, the privilege information included in the member information can be automatically applied at a time of payment.

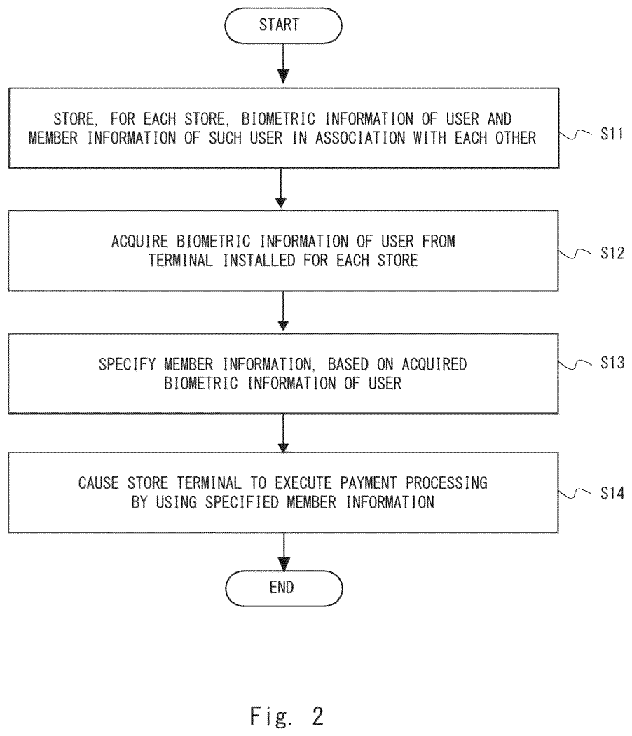

FIG. 2 is a flowchart illustrating a flow of an information processing method according to the first example embodiment. First, biometric information of a user and member information of the user are stored in association with each other for each store (S11). Next, the acquiring unit 12 acquires the biometric information of a user from a terminal installed for each store (S12).

Then, the specifying unit 13 specifies the member information, based on the acquired biometric information of a user (S13). Thereafter, the processing unit 14 causes the terminal to execute payment processing by using the specified member information (S14).

As described above, the information processing apparatus 1 according to the first example embodiment can execute payment processing in which privilege information is applied to the store terminal installed in a store by performing personal identification by biometric authentication using the biometric information of a user at a time of purchasing a product in the store, even when the user does not possess a medium indicating the privilege information being usable. For example, a point that can be acquired at a time of payment can be automatically given without presenting a member card by a user. Further, a user can automatically apply a coupon usable at the time of payment without presenting the coupon to a store clerk, and receive a discount on a product price or the like.

Note that, the information processing apparatus 1 includes a processor, a memory, and a storage apparatus as a not-illustrated configuration. The storage apparatus stores a program causing a computer to execute each piece of processing of the information processing method according to the first example embodiment. The processor reads a program from the storage apparatus into the memory, and executes the program. As a result, the processor achieves each function of the managing unit 11, the acquiring unit 12, the specifying unit 13 and the processing unit 14.

Alternatively, each component of the information processing apparatus 1 may be achieved by dedicated hardware. Further, some or all of each component of each apparatus may be achieved by circuitry in general-purpose or for a line, a processor, or the like, or a combination thereof. These may be configured by a single chip, or may be configured by a plurality of chips connected via a bus to each other. Some or all of each component of each apparatus may be achieved by a combination of the above-described circuitry or the like and a program. Further, as the processor, a central processing unit (CPU), a graphics processing unit (GPU), a field-programmable gate array (FPGA), a quantum processor (a quantum computer control chip), and the like can be used.

Further, when some or all of each component of the information processing apparatus 1 are achieved by a plurality of information processing apparatuses, pieces of circuitry, and the like, the plurality of information processing apparatuses, pieces of circuitry, and the like may be centrally arranged, or may be distributedly arranged. For example, the information processing apparatus, the circuitry, and the like may be achieved as a form in which each of the information processing apparatus, the circuitry, and the like is connected via a communication network, such as a client server system, a cloud computing system, and the like. Further, a function of the information processing apparatus 1 may be provided in a software as a service (SaaS) format.

### Second Example Embodiment

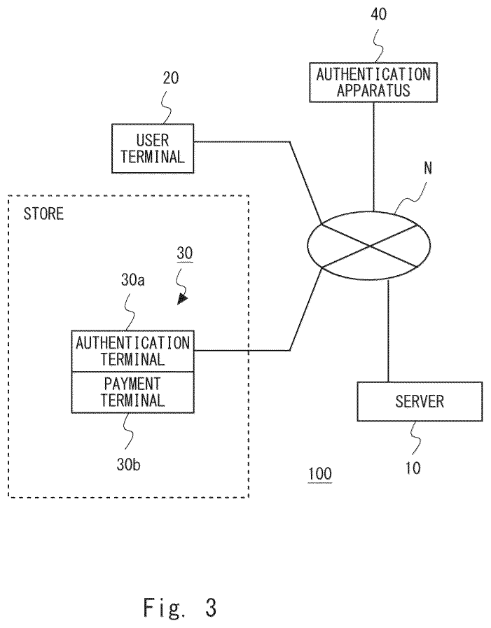

A second example embodiment is a specific example of the first example embodiment described above. FIG. 3 is a block diagram illustrating an overall configuration of an information processing system 100 according to the second example embodiment. The information processing system 100 includes a server 10, a user terminal 20, a store terminal 30, and an authentication apparatus 40. The server 10, the store terminal 30, the user terminal 20, and the authentication apparatus 40 are connected to one another via a network N. Herein, the network N is a wired or wireless communication line, for example, the Internet.

The information processing system 100 is a system for specifying member information by a member (user) of a store performing biometric authentication, and performing payment processing using the member information. Herein, an example in which registration of his/her own biometric information (for registration) is performed at a time of member registration of a store by using the user terminal 20 possessed by a user is described.

The biometric information used for biometric authentication is information used for authentication of personal identification (personal authentication, personal specifying processing, and the like), and is information for uniquely specifying (identifying) a person in question. In the second example embodiment, it is described as face authentication being one example of biometric authentication, and that biometric information is as a face image. In other words, a face image (for registration) is identification information for specifying a user to be registered as a member.

Note that, as the biometric authentication and the biometric information, other techniques using a photographed image of a person can be applied. For example, as the biometric information, data (feature amount) calculated from a physical characteristic being unique to an individual such as a fingerprint, a voice print, a vein, a retina, an iris of a pupil, and a palm pattern may be used.

### <User Terminal 20>

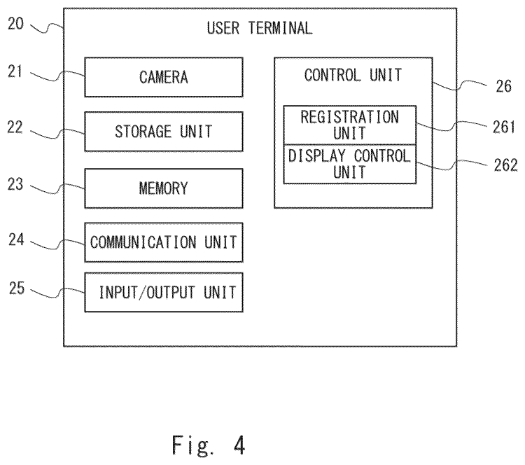

The user terminal 20 is an information terminal that a user possesses, operates, and performs transmission and reception of data to and from the server 10 via the network N by wireless communication. The user terminal 20 is a mobile phone terminal, a smartphone, a tablet terminal, or the like. FIG. 4 is a block diagram illustrating a configuration of the user terminal 20 in FIG. 3.

The user terminal 20 includes a camera 21, a storage unit 22, a memory 23, a communication unit 24, an input/output unit 25, and a control unit 26. The camera 21 is a photographing apparatus that performs photographing according to control of the control unit 26. The storage unit 22 is one example of a storage apparatus including a non-volatile memory such as a flash memory or a solid state drive (SSD). The storage unit 22 stores a program in which processing including registration processing of a face image and user information, display processing of privilege information applied in payment processing by the store terminal 30, and the like is implemented.

The memory 23 is a volatile storage apparatus such as a random access memory (RAM), and is a storage region for temporarily storing information when the control unit 26 operates. The communication unit 24 is a communication interface with the network N. Further, the communication unit 24 may establish connection for short-range wireless communication with the store terminal 30, and perform communication. Herein, various standards such as Bluetooth (registered trademark), Bluetooth low energy (BLE), and an ultra wide band (UWB) can be applied to the short-range wireless communication.

The input/output unit 25 is, for example, a touch panel including a display apparatus and an input apparatus. The control unit 26 is a processor that controls hardware included in the user terminal 20. The control unit 26 reads a program from the storage unit 22 into the memory 23, and executes the program. As a result, the control unit 26 achieves functions of a registration unit 261 and a display control unit 262.

The registration unit 261 performs registration processing of user information and a face image necessary for member registration. Specifically, the registration unit 261 accepts user information and a face image input by a user. The registration unit 261 transmits a registration request of the accepted user information and face image to the server 10 via the network N. Further, a user can register his/her own payment information in advance. The payment information is credit card information, electronic money payment information, two-dimensional code (QR code (registered trademark)) payment information, and the like, but these are merely examples.

At a time of member registration, a user may register a plurality of pieces of payment information in advance with a priority. The server 10 associates the biometric information of the user and the plurality of pieces of payment information with each other, and manages, for each store, together with priority information specifying the priority of the plurality of pieces of payment information.

As will be described later, face feature information of the user is registered in a face information DB 41 of the authentication apparatus 40, and member information is registered in a member DB 112 of the server 10. The face feature information and the member information are associated with each other by a user ID issued when the user information is registered.

The registration unit 261 may receive the user ID from the server 10 via the network N, and register the received user ID in the storage unit 22. The display control unit 262 may display the privilege information applied to the payment processing among the member information transmitted from the server 10 via the network N.

### <Store Terminal 30>

The store terminal 30 is installed in a store, and operated by a user or a store clerk. The store terminal 30 performs transmission and reception of data to and from the server 10 via the network N. The store terminal 30 is a POS terminal including an authentication terminal 30a and a payment terminal 30b. The store terminal 30 uses a result of biometric authentication of a user, and thereby performs registration processing of a product, payment processing of a price, and the like for sales of the product in a store, or the like. Note that, the store terminal 30 may be used for payment of a price for providing a service.

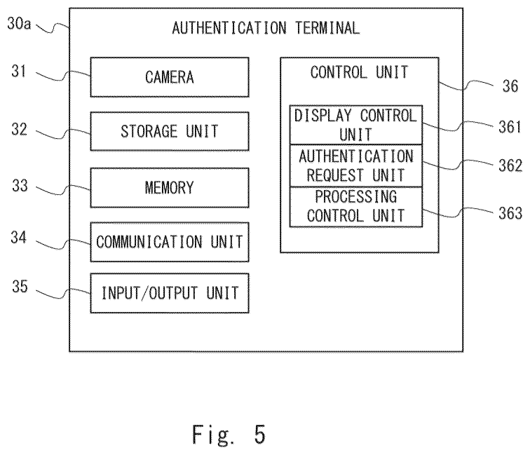

FIG. 5 is a block diagram illustrating a schematic configuration of the authentication terminal 30a in FIG. 3. As illustrated in FIG. 5, the authentication terminal 30a includes a camera 31, a storage unit 32, a memory 33, a communication unit 34, an input/output unit 35, and a control unit 36. The camera 31 is a photographing apparatus that performs photographing according to control of the control unit 36. The storage unit 32 is one example of a storage apparatus including a non-volatile memory such as a flash memory or a solid state drive (SSD). The storage unit 32 stores a program in which each piece of processing including authentication request processing for executing payment processing to be described later is implemented.

The memory 33 is a volatile storage apparatus such as a random access memory (RAM), and is a storage region for temporarily storing information when the control unit 36 operates. The communication unit 34 is a communication interface with the network N. The input/output unit 35 is, for example, a touch panel including a display apparatus (display unit) of a screen or the like, and an input apparatus (input unit).

The control unit 36 is a processor that controls hardware included in the authentication terminal 30a. The control unit 36 reads a program from the storage unit 32 into the memory 33, and executes the program. As a result, the control unit 36 achieves functions of a display control unit 361, an authentication request unit 362, and a processing control unit 363.

The display control unit 361 causes the input/output unit 35 to display a screen generated by execution of the program. The display control unit 361 may display a message prompting face photographing for face authentication. Further, the display control unit 361 may display the privilege information applied to the payment processing among the member information transmitted from the server 10.

The authentication request unit 362 extracts a face region of a person as a face image from an image photographing a user by the camera 31, and transmits an authentication request to the server 10. Note that, the authentication request unit 362 may transmit an authentication request including a face image to the authentication apparatus 40. When the authentication is successful, member information associated with the face image is transmitted from the server 10 to the processing control unit 363.

The processing control unit 363 controls processing being unique to the payment terminal 30b connected to the authentication terminal 30a. For example, the processing control unit 363 causes the payment terminal 30b to execute the payment processing using the member information when the authentication is successful. Further, when receiving, from the server 10, information desired to be notified to a user in payment applying the member information, the processing control unit 363 causes the display control unit 361 to display the information. Further, when receiving, from the server 10, information desired to be notified to a user in the payment applying the member information, the processing control unit 363 may output the information to the user terminal 20.

The information desired to be notified to a user includes, for example, at least one of the privilege information applied for each piece of payment, the acquired privilege information, and a cumulative value of the privilege information. Specifically, the information desired to be notified to a user is a point given in current shopping, a cumulative value of the points given in a predetermined period, a coupon usable for next shopping, or the like.

The payment terminal 30b is an apparatus that accepts payment for purchasing a product or the like. The payment may be a cash payment, or may be a non-cash payment such as a credit card, a debit card, or electronic money. In order to accept payment using cash, a card, or the like, the payment terminal 30b includes a cash input port, an automatic change machine, a card reader, and the like. Further, the payment terminal 30b includes a display apparatus such as a liquid crystal display for displaying information related to a product to be purchased, privilege information to be applied, payment information to be used in payment processing, and the like.

As described above, payment information such as a valid credit card that can be used for payment and electronic money can be registered in advance at a time of member registration. In this case, the payment terminal 30b can automatically perform the payment processing in response to success of face authentication. When the authentication is successful, the payment processing is executed by using the registered payment information. When a plurality of pieces of payment information are registered together with the priority information, the processing control unit 363 causes the payment terminal 30b to execute the payment processing by using the payment information having a next priority when the payment using the payment information having a higher priority cannot be performed.

When the payment using the payment information having a higher priority cannot be performed, the processing control unit 363 may notify a user of the fact and use of the payment information having the next priority. Further, when the payment information having a higher priority is electronic money and the electronic money is insufficient in balance, the processing control unit 363 can output information for causing a user to select whether to pay by electronic money by charging or to use the payment information having a next high priority.

### <Authentication Apparatus 40>

The authentication apparatus 40 is an information processing apparatus that manages face feature information of a user and performs face authentication. Further, in response to an authentication request received from outside, the authentication apparatus 40 performs collation of a face image (for authentication) included in the request with the face feature information of a user to be managed, and replies a collation result (authentication result) to a request source.

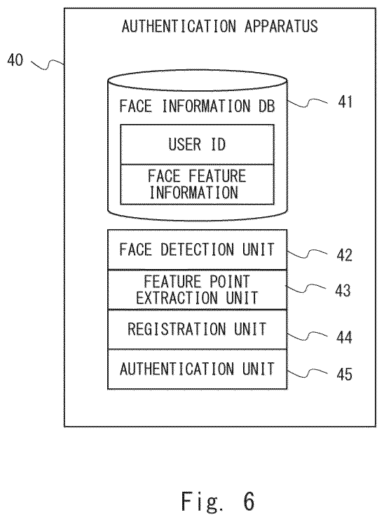

FIG. 6 is a block diagram illustrating a configuration of the authentication apparatus 40 in FIG. 3. The authentication apparatus 40 includes the face information database (DB) 41, a face detection unit 42, a feature point extraction unit 43, a registration unit 44, and an authentication unit 45. The face information DB 41 stores face feature information being a set of feature points extracted from a face image (for registration). The face information DB 41 stores a user ID described later and face feature information in association with each other. Note that, the authentication apparatus 40 may delete the face feature information in the face feature DB 41 in response to a request from a user or the like associated to the face feature information. Alternatively, the authentication apparatus 40 may delete the face feature information after a certain period of time has elapsed from registration.

The face detection unit 42 detects a face region included in a face image (for registration) for registering face feature information, and outputs the detected face region to the feature point extraction unit 43. The feature point extraction unit 43 extracts a feature point from the face region of the face image (for registration) received from the user terminal 20 or the like, and outputs the face feature information to the registration unit 44. The registration unit 44 newly issues a user ID when registering the face feature information. The registration unit 44 registers the issued user ID and the face feature information extracted from the face image (for registration) in association with each other in the face information DB 41.

Further, the face detection unit 42 detects a face region included in a face image (for authentication) used in authentication processing, and outputs the detected face region to the feature point extraction unit 43. Further, the feature point extraction unit 43 extracts a feature point included in the face image (for authentication) received from the server 10 or the like, and outputs the face feature information to the authentication unit 45.

The authentication unit 45 performs face authentication using the face feature information. Specifically, the authentication unit 45 performs collation of the face feature information extracted from the face image (for authentication) with the face feature information in the face information DB 41. The authentication unit 45 replies presence or absence of matching of the face feature information to a request source as a face authentication result. The presence or absence of the matching of the face feature information corresponds to success or failure of the authentication. Note that, matching the face feature information refers to a case where a degree of coincidence is equal to or greater than a threshold value. Further, when the face authentication is successful, the face authentication result includes the specified user ID.

For example, when an authentication request is transmitted from the server 10, the authentication unit 45 performs face authentication on a face image included in the authentication request, and replies an authentication result to the server 10. When the authentication is successful, a specifying unit 13 of the server 10 specifies the member information associated with the collated face feature information.

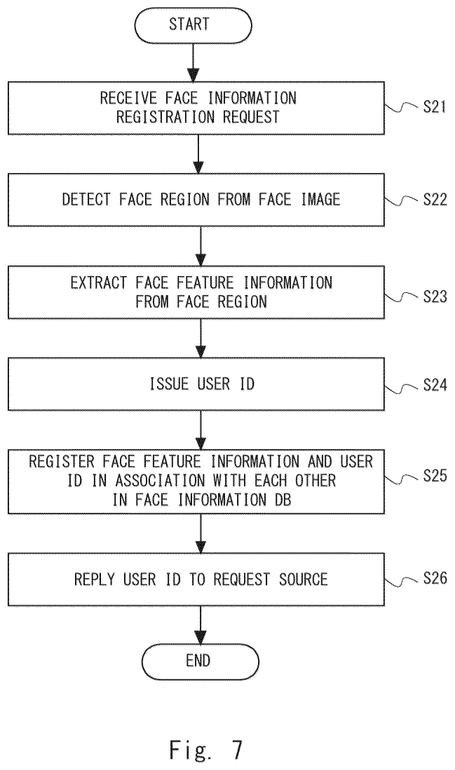

FIG. 7 is a flowchart illustrating a flow of face information registration processing performed by the authentication apparatus 40 according to the second example embodiment. First, the authentication apparatus 40 receives a registration request of a face image transmitted from the user terminal 20 (S21). In this example, the authentication apparatus 40 receives the registration request of the face image transmitted from the user terminal 20 via the server 10. Next, the face detection unit 42 detects a face region from the face image included in the face information registration request (S22). Then, the feature point extraction unit 43 extracts a feature point (face feature information) from the face region detected in step S22 (S23). Then, the registration unit 44 issues a user ID (S24), and registers the issued user ID in association with the extracted face feature information in the face information DB 41 (S25).

Thereafter, the registration unit 44 replies the issued user ID to a request source (e.g., the server 10) (S26). Note that, the authentication apparatus 40 may perform face information registration processing in response to a face information registration request received from any information registration terminal. For example, the information registration terminal may be the user terminal 20 or the store terminal 30.

### <Server 10>

The server 10 corresponds to the information processing apparatus 1. The server 10 is an information processing apparatus that performs biometric information registration processing, member information specifying processing, and the like (an information processing method according to the second example embodiment). In the first example embodiment, the information processing apparatus 1 stores biometric information and management information in association with each other, but in the second example embodiment, the server 10 manages the biometric information and the management information in cooperation with the authentication apparatus 40. Note that, the server 10 may be configured by a plurality of servers, and each functional block may be achieved by a plurality of computers.

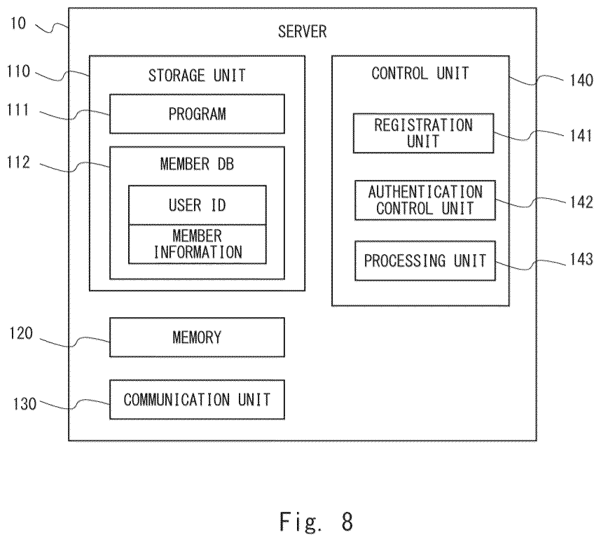

FIG. 8 is a block diagram illustrating a configuration of the server 10 in FIG. 3. The server 10 includes a storage unit 110, a memory 120, a communication unit 130, and a control unit 140. The storage unit 110 is one example of a storage apparatus such as a hard disk and a flash memory. The storage unit 110 stores a program 111 and the member DB 112. The program 111 is a computer program in which a part of registration processing of a face image and user information, face authentication processing, payment processing, and the like is implemented.

The member DB 112 is a database that manages information of a person registered as a member among users of a store. The member DB 112 manages the user ID and the member information in association with each other. In other words, in the second example embodiment, the biometric information and the member information are associated with the user ID, and are managed, for each store, by the member DB 112 of the server 10 and the face information DB 41 of the authentication apparatus 40. The biometric information is a face image herein. Further, as described above, the member information includes user information, various types of attribute information such as privilege information, and payment information. The payment information is credit card information, electronic payment information, or the like used when the payment terminal 30b performs payment processing in response to success of biometric authentication.

The memory 120 is a volatile storage apparatus such as a random access memory (RAM), and is a storage region for temporarily storing information when the control unit 140 operates. The communication unit 130 is a communication interface with the network N.

The control unit 140 is a processor that controls each configuration of the server 10. The control unit 140 reads the program 111 from the storage unit 110 into the memory 120, and executes the program 111. As a result, the control unit 140 achieves functions of a registration unit 141, an authentication control unit 142, and a processing unit 143.

The registration unit 141 is equivalent to the managing unit 11 in FIG. 1. The registration unit 141 receives, from any user terminal 20, a member registration request including a face image and a predetermined matter (user information) related to a user necessary for member registration, and performs registration processing of the face image and the user information. Specifically, the registration unit 141 acquires a face image from a member registration request, and transmits a face information registration request including the acquired face image to the authentication apparatus 40. Then, the registration unit 141 receives the user ID issued at a time of registration of the face information from the authentication apparatus 40. Then, the registration unit 141 acquires the user information from the member registration request, and registers the received user ID and the user information in the member DB 112 in association with each other.

The authentication control unit 142 is equivalent to the acquiring unit 12 and the specifying unit 13 in FIG. 1. When an authentication request including a face image of a member is received from the store terminal 30, the authentication control unit 142 transmits an authentication request including the face image to the authentication apparatus 40. Then, the authentication control unit 142 receives a face authentication result from the authentication apparatus 40. When the face authentication is successful, the authentication control unit 142 specifies the member information associated with the collated face feature information.

The processing unit 143 is equivalent to the processing unit 14 in FIG. 1. The processing unit 143 executes payment processing by using the member information specified by the store terminal 30. Specifically, the processing unit 143 can execute the payment processing to which the privilege information included in the member information is applied at a time of payment in the payment terminal 30b. For example, a user can acquire a point according to a payment amount at a time of payment without presenting a member card. Further, a user can automatically apply a coupon usable at the time of payment without presenting the coupon to a store clerk, and receive a discount on a product price or the like.

Furthermore, when the payment information is registered in the member DB 112 in advance, the processing unit 143 can read the payment information associated with the user ID specified when the face authentication is successful, and transmit the read payment information to the payment terminal 30b. The payment terminal 30b can perform the payment processing of a payment amount by using the payment information. Note that, the member DB 112 may store, for each store, a plurality of pieces of payment information for one user ID, together with the priority information specifying the priority of the payment information. In this case, the processing unit 143 can cause the payment terminal 30b to execute the payment processing by using the payment information having a next priority when the payment using the payment information having a higher priority cannot be performed.

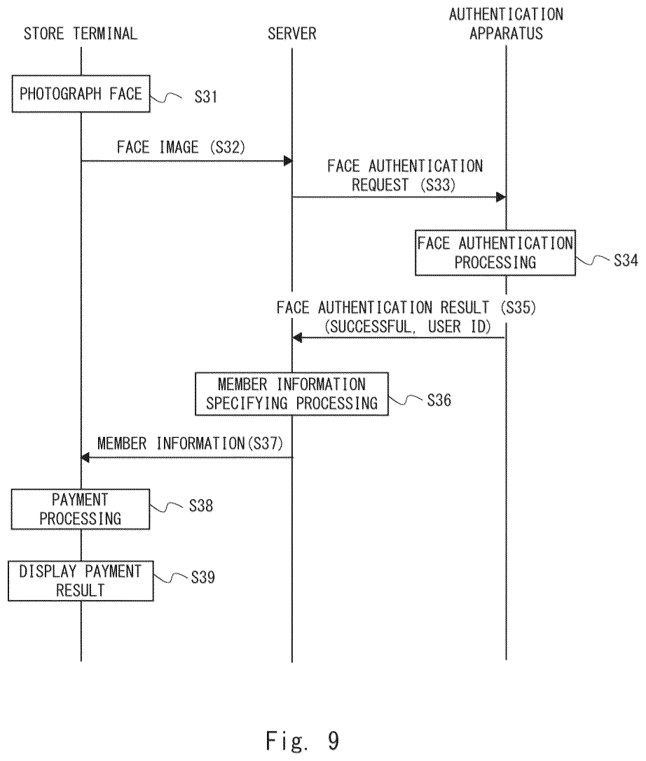

FIG. 9 is a sequence diagram illustrating a flow of the payment processing. First, the authentication terminal 30a of the store terminal 30 photographs a face of a user with the camera 31 (S31). Then, the authentication terminal 30a outputs a face image to the server 10 (S32). The server 10 acquires the face image from the authentication terminal 30a, and transmits a face authentication request including the acquired face image to the authentication apparatus 40 via the network N (S33). When receiving the face authentication request, the authentication apparatus 40 performs face authentication processing (S34).

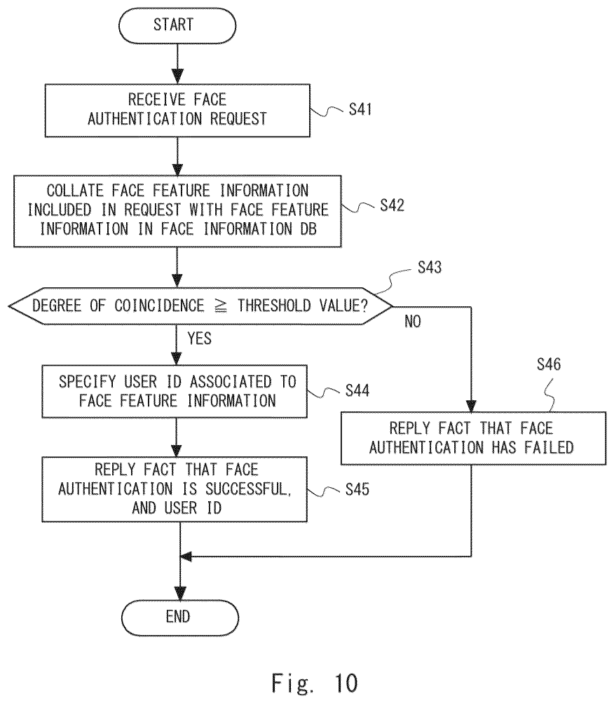

FIG. 10 is a flowchart illustrating a flow of the face authentication processing performed by the authentication apparatus 40. First, the authentication apparatus 40 receives a face authentication request from the server 10 via the network N (S41). Note that, the authentication apparatus 40 may receive a face authentication request from the store terminal 30 or the like. Next, the authentication apparatus 40 extracts face feature information from a face image included in the face authentication request. Then, the authentication unit 45 of the authentication apparatus 40 collates the face feature information extracted from the face image included in the face authentication request with face feature information in the face information DB 41 (S42), and calculates a degree of coincidence.

Then, the authentication unit 45 determines whether the degree of coincidence is equal to or greater than a threshold value (S43). When the face feature information matches, that is, when the degree of coincidence of the face feature information is equal to or greater than the threshold value, the authentication unit 45 specifies a user ID associated with the face feature information (S44). Then, the authentication unit 45 replies, to the server 10 via the network N, a face authentication result including a fact that the face authentication is successful and the specified user ID (S45). When the degree of coincidence is less than the threshold value in step S43, the authentication unit 45 replies, to the server 10 via the network N, a face authentication result including a fact that the face authentication has failed (S46).

Returning back to FIG. 9, the server 10 receives the face authentication result from the authentication apparatus 40 via the network N (S35). Then, the server 10 executes member information specifying processing in response to the face authentication result (S36). When the face authentication is successful, the server 10 reads member information associated with the user ID included in the face authentication result from the member DB 112, and transmits the read member information to the store terminal 30 (S37).

When the face authentication has failed, the server 10 can transmit a fact that the authentication has failed to the store terminal 30. The store terminal 30 displays on a screen that application of the member information by the face authentication is not possible. Further, the store terminal 30 may notify the user terminal 20 of a fact that specifying the member information by the face authentication cannot be performed by short-range wireless communication or the like. Note that, the face authentication request may be directly transmitted from the authentication terminal 30a of the store terminal 30 to the authentication apparatus 40 without passing through the server 10, and the authentication apparatus 40 may transmit the face authentication result to the server 10.

Then, the payment terminal 30b of the store terminal 30 executes the payment processing by applying the member information (S38).

Herein, it is assumed that the following attribute information is stored in the member DB 112 for a store A and a store B.

### Store A

Coupon: Automatically apply a usable coupon
Points: Automatically give a store point
Payment method: Electronic payment

### Store B

Coupon: Automatically apply a usable coupon
Points: Automatically give a store point, and a tie-up point
Payment method: Credit card

For example, when the payment processing is executed in the above-described store B, the store terminal 30 confirms a condition (an expiration date, an application condition, and the like) of a coupon associated with a face image of a member, and automatically applies all usable coupons. Note that, when there are a plurality of usable coupons but they cannot be used in duplicate, the store terminal 30 may transmit selectable coupon information to the user terminal 20. A user can select a coupon desired to be used from a plurality of coupons, and apply the coupon at a time of payment.

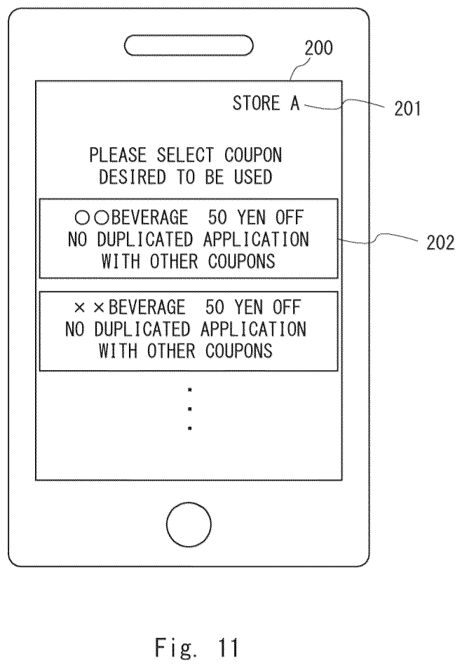

FIG. 11 is a diagram illustrating one example of a coupon selection screen 200 displayed on the user terminal 20. The coupon selection screen 200 includes an application store display 201 performing payment to which a coupon is applied, and a coupon information display 202 being selectable. In the example illustrated in FIG. 11, a store that performs payment is the store A. The coupon information display 202 includes a list of selectable coupon information. When a user presses a button of a coupon desired to be used from the coupons, information on the coupon to be used can be transmitted from the user terminal 20 to the store terminal 30.

Further, the store terminal 30 automatically gives a store point specific to a store and a tie-up point that can be commonly used in an affiliate according to a payment amount. Further, the store terminal 30 performs payment processing on the payment amount by using credit card information registered in the member DB 112.

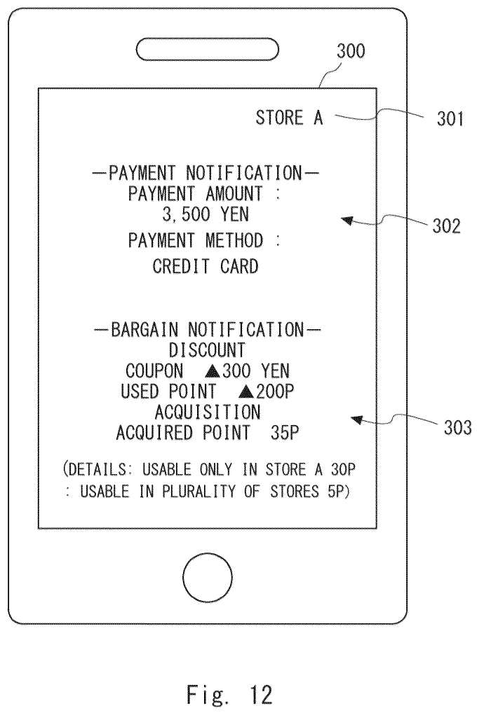

Then, the store terminal 30 displays a payment result (S39). The store terminal 30 may notify the user terminal 20 of the payment result by the short-range wireless communication. Further, the store terminal 30 may notify a user of the payment result by an application or a mail. In a case of notification by the application or the mail, a user can confirm the payment result and a cumulative value of acquisition points at any timing. FIG. 12 illustrates one example of a screen on which the payment result is displayed. As illustrated in FIG. 12, on a screen of the store terminal 30, information desired to be notified to a user in the payment to which the member information is applied is displayed. Note that, information desired to be notified to a staff of a store may be displayed on a display apparatus of a store side.

A payment result screen 300 includes an application store display 301, a payment notification information display 302, and a bargain notification information display 303. In the example in FIG. 12, it is illustrated that a store where the payment is executed is the store A among the plurality of stores.

Further, in the example in FIG. 12, together with the payment notification information display 302 including a payment amount and a payment method, the bargain notification information display 303 including a discount amount by a coupon applied in current shopping, the number of points used in the current shopping, and the point acquired in the current shopping is displayed. Note that, the acquisition point may include a point that can be used only in the store A and a common point that can be used in a plurality of stores. As a result, a user being a member can know how much money has been gained in the current shopping, and can increase a user's desire to purchase at a store. Further, the store terminal 30 may display the cumulative value of the acquisition points.

Note that, the attribute information illustrated in FIG. 12 is one example, and other information may be displayed in addition to or instead of the information illustrated herein. Further, the screen illustrated in FIG. 12 may be displayed not only on a user side but also on a display for a store clerk of the store side.

Furthermore, the store terminal 30 can issue a coupon usable at next shopping. For example, the control unit 36 of the store terminal 30 issues a coupon according to a purchased product, and transmits the issued coupon to the server 10. The server 10 can store the received coupon in the member DB 112 as attribute information (member information) of the member. Further, the store terminal 30 may notify the user terminal 20 of the acquired coupon by the short-range wireless communication. For example, by issuing information related to a discount of a product related to a purchased product as a coupon, it is possible to increase a user's desire to purchase and to promote sales of a product in a store. Further, it is also possible to acquire an advertisement revenue from a business operator that manufactures a product related to a coupon.

As described above, according to the second example embodiment, it is possible to complete payment processing in which privilege information such as a coupon and a point is automatically applied only by performing face authentication with the store terminal 30 installed in a store. As a result, it is not necessary to carry the member card, and it is also possible to prevent from forgetting to use a usable coupon, and to reduce time and effort of a user and use the privilege conveniently and easily. Such promotion of use of a point and a coupon service enables customer retention.

In the examples described above, a program includes instructions (or software code) that, when loaded into a computer, cause a computer to perform one or more of the functions described in the example embodiments. The program may be stored in a non-transitory computer-readable medium or a tangible storage medium. By way of example, and not limitation, the computer-readable medium or the tangible storage medium includes a random-access memory (RAM), a read-only memory (ROM), a flash memory, a solid-state drive (SSD), or other memory techniques, a CD-ROM, a digital versatile disc (DVD), a Blu-ray (registered trademark) disk, or other optical disk storage, or a magnetic cassette, a magnetic tape, a magnetic disk storage, or other magnetic storage devices. The program may be transmitted on a transitory computer-readable medium or a communication medium. By way of example, and not limitation, the transitory computer-readable medium or the communication medium includes a propagation signal in electrical, optical, acoustic, or other forms.

Note that, the present disclosure is not limited to the above-described example embodiment, and can be appropriately modified without departing from the spirit thereof. Further, the present disclosure may be implemented by appropriately combining each of the example embodiments.

Some or all of the above-described example embodiments may also be described as the following supplementary notes, but are not limited thereto.

### Supplementary Note A1

An information processing apparatus including:
a managing means for managing, for each store, biometric information of a user and member information in association with each other;
an acquiring means for acquiring biometric information of a user from a terminal installed for each store;
a specifying means for specifying member information, based on the acquired biometric information of a user; and
a processing means for causing the terminal to execute payment processing by using the specified member information.

### Supplementary Note A2

The information processing apparatus according to supplementary note A1, wherein
the managing means manages, for each store, biometric information of a user and a plurality of pieces of payment information in association with each other, together with priority information specifying a priority of a plurality of pieces of payment information, and
the processing means causes the terminal to execute payment processing by using payment information having a next priority when payment using payment information having a higher priority cannot be performed.

### Supplementary Note A3

The information processing apparatus according to supplementary note A1 or A2, wherein the processing means causes the terminal to output information desired to be notified to a user in payment to which the member information is applied.

### Supplementary Note A4

The information processing apparatus according to supplementary note A3, wherein the information includes at least one of privilege information applied for each piece of payment, acquired privilege information, and a cumulative value of privilege information.

### Supplementary Note B1

An information processing system including:
a terminal installed for each store; and
an information processing apparatus, wherein
the information processing apparatus includes
a managing means for managing, for each store, biometric information of a user and member information in association with each other,
an acquiring means for acquiring biometric information of a user from the terminal, and
a specifying means for specifying member information, based on the acquired biometric information of a user, and
the terminal executes payment processing on the terminal by using the specified member information.

### Supplementary Note B2

The information processing system according to supplementary note B1, wherein
the managing means manages, for each store, biometric information of a user and a plurality of pieces of payment information in association with each other, together with priority information specifying a priority of a plurality of pieces of payment information, and
the terminal executes payment processing by using payment information having a next priority when payment using payment information having a higher priority cannot be performed.

### Supplementary Note B3

The information processing system according to supplementary note B1 or B2, wherein the terminal outputs information desired to be notified to a user in payment to which the member information is applied.

### Supplementary Note B4

The information processing system according to supplementary note B3, wherein the information includes at least one of privilege information applied for each piece of payment, acquired privilege information, and a cumulative value of privilege information.

### Supplementary Note C1

An information processing method including,
by a computer:
managing, for each store, biometric information of a user and member information in association with each other;
acquiring biometric information of a user from a terminal installed for each store;
specifying member information, based on the acquired biometric information of a user; and
causing the terminal to execute payment processing by using the specified member information.

### Supplementary Note D1

A non-transitory computer-readable medium storing a program for causing a computer to execute:
processing of managing, for each store, biometric information of a user and member information in association with each other;
processing of acquiring biometric information of a user from a terminal installed for each store;
processing of specifying member information, based on the acquired biometric information of a user; and
processing of causing the terminal to execute payment processing by using the specified member information.

Although the invention of the present application has been described with reference to the example embodiments (and examples), the invention of the present application is not limited to the above-described example embodiments (and examples). Various modifications that can be understood by a person skilled in the art within the scope of the invention of the present application can be made to the configuration and details of the invention of the present application.

### REFERENCE SIGNS LIST

1 INFORMATION PROCESSING APPARATUS
10 SERVER
11 MANAGING UNIT
12 ACQUIRING UNIT
13 SPECIFYING UNIT
14 PROCESSING UNIT
20 USER TERMINAL
21 CAMERA
22 STORAGE UNIT
23 MEMORY
24 COMMUNICATION UNIT
25 INPUT/OUTPUT UNIT
26 CONTROL UNIT
261 REGISTRATION UNIT
262 DISPLAY CONTROL UNIT
30 STORE TERMINAL
30a AUTHENTICATION TERMINAL
30b PAYMENT TERMINAL
31 CAMERA
32 STORAGE UNIT
33 MEMORY
34 COMMUNICATION UNIT
35 INPUT/OUTPUT UNIT
36 CONTROL UNIT
361 DISPLAY CONTROL UNIT
362 AUTHENTICATION REQUEST UNIT
363 PROCESSING CONTROL UNIT
40 AUTHENTICATION APPARATUS
41 FACE INFORMATION DB
42 FACE DETECTION UNIT
43 FEATURE POINT EXTRACTION UNIT
44 REGISTRATION UNIT
45 AUTHENTICATION UNIT
100 INFORMATION PROCESSING SYSTEM
110 STORAGE UNIT
111 PROGRAM
112 MEMBER DB
120 MEMORY
130 COMMUNICATION UNIT
140 CONTROL UNIT
141 REGISTRATION UNIT
142 AUTHENTICATION CONTROL UNIT
143 PROCESSING UNIT
200 COUPON SELECTION SCREEN
201 APPLICATION STORE DISPLAY
202 COUPON INFORMATION DISPLAY
300 PAYMENT RESULT SCREEN
301 APPLICATION STORE DISPLAY
302 PAYMENT NOTIFICATION INFORMATION DISPLAY
303 BARGAIN NOTIFICATION INFORMATION DISPLAY
N NETWORK

What is claimed is:

1. An information processing apparatus comprising:
at least one memory storing instructions, and
at least one processor configured to execute the instructions to;
manage, for each store, biometric information of a user and member information in association with each other;
acquire biometric information of a user from a terminal installed for each store;
specify member information, based on the acquired biometric information of a user; and
cause the terminal to execute payment processing by using the specified member information.

2. The information processing apparatus according to claim 1, wherein at least one processor configured to execute the instructions to;
manage, for each store, biometric information of a user and a plurality of pieces of payment information in association with each other, together with priority information specifying a priority of a plurality of pieces of payment information, and
cause the terminal to execute payment processing by using payment information having a next priority when payment using payment information having a higher priority cannot be performed.

3. The information processing apparatus according to claim 1, wherein at least one processor configured to execute the instructions to cause the terminal to output information desired to be notified to a user in payment to which the member information is applied.

4. The information processing apparatus according to claim 3, wherein the information includes at least one of privilege information applied for each piece of payment, acquired privilege information, and a cumulative value of privilege information.

5-8. (canceled)

9. An information processing method comprising,
by a computer:
managing, for each store, biometric information of a user and member information in association with each other;
acquiring biometric information of a user from a terminal installed for each store;
specifying member information, based on the acquired biometric information of a user; and
causing the terminal to execute payment processing by using the specified member information.

10. A non-transitory computer-readable medium storing a program for causing a computer to execute:
processing of managing, for each store, biometric information of a user and member information in association with each other;
processing of acquiring biometric information of a user from a terminal installed for each store;
processing of specifying member information, based on the acquired biometric information of a user; and
processing of causing the terminal to execute payment processing by using the specified member information.

11. The non-transitory computer-readable medium according to claim 10, wherein the program causes the computer to execute;
processing of managing, for each store, biometric information of a user and a plurality of pieces of payment information in association with each other, together with priority information specifying a priority of a plurality of pieces of payment information, and
processing of causing the terminal to execute payment processing by using payment information having a next priority when payment using payment information having a higher priority cannot be performed.

12. The non-transitory computer-readable medium according to claim 10, wherein the program causes the computer to execute processing of causing the terminal to output information desired to be notified to a user in payment to which the member information is applied.

13. The non-transitory computer-readable medium according to claim 12, wherein the information includes at least one of privilege information applied for each piece of payment, acquired privilege information, and a cumulative value of privilege information.
